(19) United States
(12) Patent Application Publication
(10) Pub. No.: US 2017/0205268 A1
(43) Pub. Date: Jul. 20, 2017

(54) FUEL MONITORING SYSTEM AND METHOD

(71) Applicant: Qualza, Inc., Livermore, CA (US)

(72) Inventors: Sameer Misson, Livermore, CA (US); Hakam Misson, Livermore, CA (US)

(21) Appl. No.: 15/406,433

(22) Filed: Jan. 13, 2017

Related U.S. Application Data
(60) Provisional application No. 62/279,542, filed on Jan. 15, 2016.

(51) Int. Cl. G01F 23/00; G06F 17/30

(52) U.S. Cl. CPC G01F 23/0076; G06F 17/30979; G01F 23/0007

(57) ABSTRACT

A monitoring device, and associated methods of operation, for managing fuel distribution systems to improve performance. The monitoring device includes a connector configured to mate with a communications port of a fuel distribution system. The device further includes a processor configured to communicate with the fuel distribution system or a computer associated therewith when the connector is mated with the communications port. The processor obtains fuel information from the fuel distribution system, such as fuel level, fuel temperature/pressure, and/or other suitable information. The obtained information is transmitted to a remote database for processing via a transmitter. An electronic device in communication with the database and/or the monitoring device presents the obtained fuel information to an operator and may further present any identified performance issues relating to the fuel distribution system, where the electronic device may be used to resolve such performance issues.

### RELATED APPLICATION DATA

This application is a nonprovisional of and claims the benefit under 35 U.S.C. §119(e) of U.S. Provisional Patent Application No. 62/279,542, filed Jan. 15, 2016, the disclosure of which is incorporated by reference herein in its entirety.

### BACKGROUND

The field of the present disclosure relates to systems and methods for monitoring and managing fuel distribution systems, and in particular, to such systems and related methods for on-site management of fuel levels and streamlining fuel delivery.

Many modern gas stations use on-site automatic tank gauges and fuel management systems to obtain a variety of data and information. For example, such systems may be used to monitor fuel levels of on-site tanks, to monitor temperature and other parameters relating to the stored fuel, to review error codes or alarms, to detect leaks in fuel storage tanks, and/or to obtain other information relating to the on-site fuel storage tanks. These on-site systems are standalone units that provide information for an individual storage tank or a set of storage tanks at a specific site. However, such on-site systems typically do not communicate with other remote systems, such as a central server or database. Accordingly, an operator cannot easily monitor multiple gas stations at different sites, such as to determine relative fuel volumes for each of the storage tanks at various locations, without having to visit or otherwise contact other operators or personnel at each location to gather data from each individual on-site system.

The present inventors have, therefore, determined that it would be desirable to have a monitoring device with improved performance features, where the device is operable to transmit information from individual on-site monitoring systems over a network to a database or server. Additional aspects and advantages of such a monitoring device will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 is a view of a monitoring device for transmitting data from an on-site fuel monitoring system in accordance with one embodiment.

FIG. 2 is an exploded view of the monitoring device of FIG. 1.

FIG. 3 is a schematic drawing illustrating internal electronics components on a first side of a printed circuit board of the monitoring device of FIG. 1.

FIG. 4 is a schematic drawing illustrating internal electronics components on a second side of the printed circuit board of the monitoring device of FIG. 1.

FIG. 5 is a flowchart illustrating an example method of installing and using the monitoring device of FIG. 1 to create a database for a plurality of gas stations.

FIG. 6 is a flowchart illustrating an example method of using the monitoring device of FIG. 1 to generate an alert signal in response to occurrence of monitored events.

FIG. 7 is a flowchart illustrating an example method of a fuel refinery or other fuel provider using the database to anticipate and satisfy fuel demands.

FIG. 8 is a flowchart illustrating an example method of a fuel consumer using the database to receive promotions and fuel information.

### DETAILED DESCRIPTION OF DISCLOSED EMBODIMENTS

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

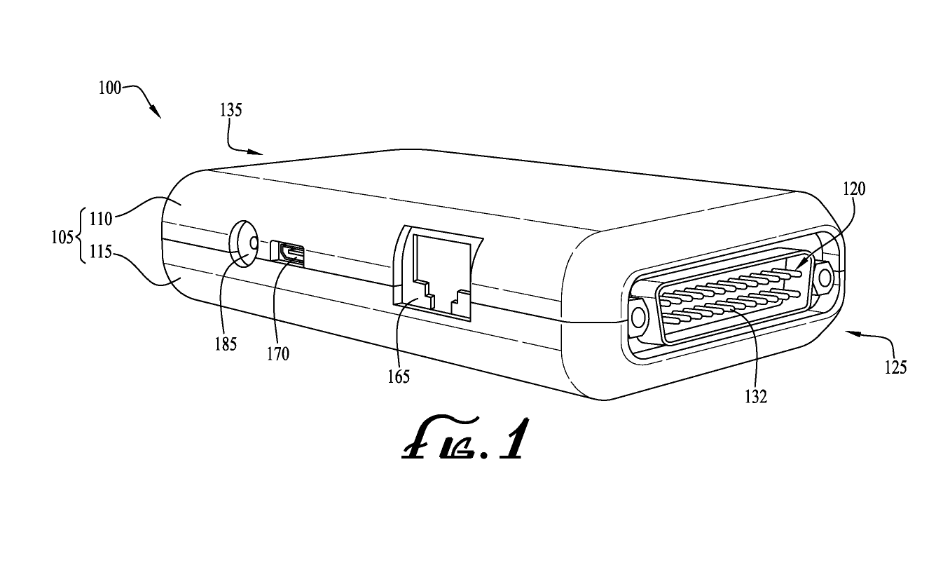

FIGS. 1-8 collectively illustrate embodiments of a portable monitoring device 100 and methods for operating the monitoring device 100 to collect data from a plurality of individual, on-site fuel monitoring systems 150 and to transmit the collected data to a central database/server 155. In an example embodiment, an operator, such as an owner or manager of a fuel dispensing station (e.g., a gas station) is able to access the database/server 155 to monitor and manage a variety of gas stations from a central location. For example, the operator may monitor fuel storage levels across a plurality of gas stations, fuel consumption history for each gas station, and error codes relating to specific storage tanks, and based on the collective information, determine necessary steps for proceeding and/or resolving specific issues. The operator may also monitor other parameters, such as fuel volume per tank, ullage, temperature, pressure, water levels, water depth, tank volume in depth, or other suitable measurements. As is further explained in detail below, this streamlined system provides an effective strategy for managing a portfolio of gas stations.

In other embodiments, as further described in detail below, the collected data may be accessed by a fuel provider to anticipate consumer fuel delivery needs. For example, in one embodiment, the collected data stored on the central server 155 (or a different subset of data synthesized from the collected raw data) may be accessible to a fuel refinery or other fuel provider(s)/distributor(s) to allow the refinery/provider(s) to monitor fuel demands.

In other embodiments, as further described in detail below, the collected data (or a different subset of data synthesized from the collected raw data) may be accessible to a fuel refinery or other fuel provider(s) to allow the refinery/provider(s) to monitor fuel demands and/or anticipate consumer fuel delivery needs. The fuel provider may obtain the information in a variety of ways. For example, the fuel provider may directly access the central server 155 or may receive push messages to an electronic device 160 (e.g., a mobile device, cellular phone, tablet, computer, or other suitable electronic device) to obtain information that a fueling station in a specific city requires a delivery of 20,000 gallons of fuel to satisfy anticipated demand in advance of a long weekend.

In still other embodiments, the central server 155 may cooperate with a fuel consumer's tablet or mobile device 160 to communicate advertisements and promotional offers from specific gas stations. In such embodiments, individual gas station operators may provide the server 155 with specific instructions relating to targeted advertisements and the messages contained therein.

With collective reference to FIGS. 1-8, the following sections describe additional details of these and other embodiments of the monitoring device 100, along with details relating to example methods of installation of the device 100 and use of the data obtained via the device 100.

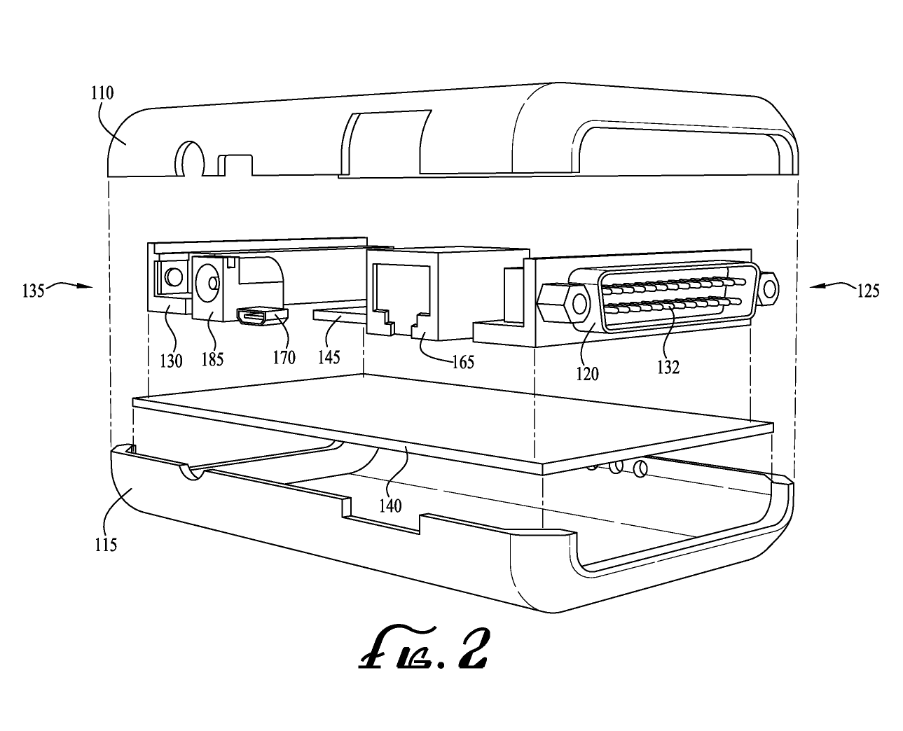

With particular reference to FIGS. 1 and 2, the device 100 includes a housing 105 that may be arranged in a clamshell configuration with a first (or upper) housing portion 110 and a second (or lower) housing portion 115. A connector body 120 is arranged along a front portion 125 of the housing 105, and a second connector body 130 is arranged along a rear portion 135 of the housing 105. In one embodiment, each of the first and second housing portions 110, 115 is manufactured of a plastic material as a single, monolithic component. In such embodiments, the housing portions 110, 115 may be coupled to one another via corresponding snap-fit features, fasteners, or other suitable fastening mechanisms. It should be understood that in other embodiments, the first and second housing portions 110, 115 may instead be manufactured from other suitable materials different than those specifically mentioned herein.

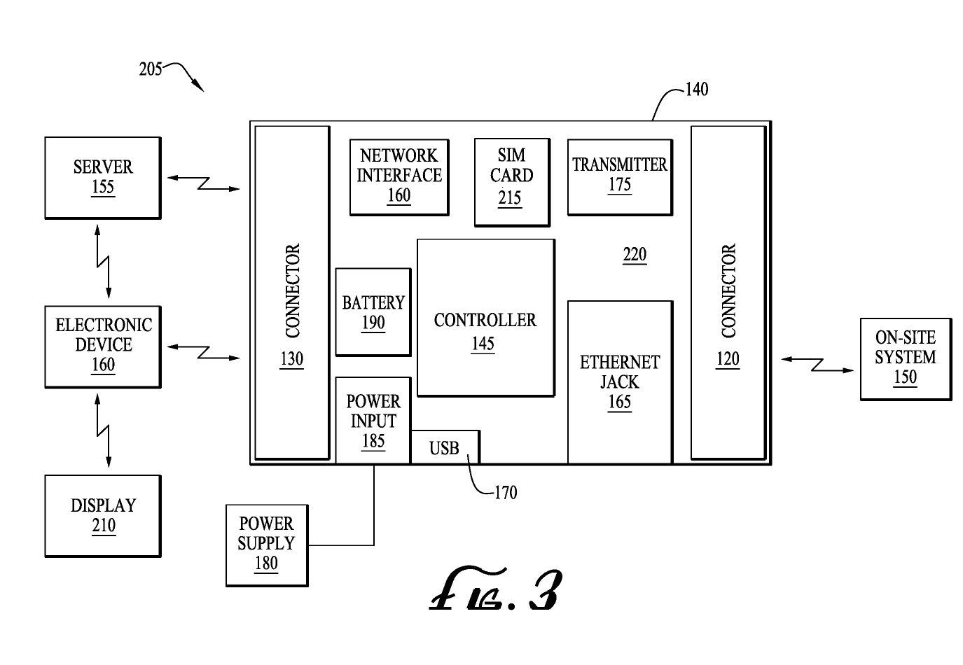

The connector bodies 120, 130 each include a plurality of connector pins 132 operable to facilitate connection of the device 100 with an on-site fuel monitoring system 150 (see FIG. 3). For example, in one embodiment, the connector bodies 120, 130 may each be a D-sub 25 pin male connector operable to mate with a similar female connector of the on-site monitoring system 150. Since many on-site monitoring systems 150 utilize the D-sub 25 configuration, the written description and figures may specifically reference this configuration. However, it should be understood that the connector bodies 120, 130 may include any one of a variety of connector interfaces to cooperate with a specific configuration of the on-site monitoring system 150 with which the device 100 is to be used.

With reference to FIG. 2, the device 100 further includes a printed circuit board (PCB) 140 for receiving and integrating various components of the device 100, including the connector bodies 120, 130 described previously. These and other components of the monitoring device 100 are described with reference to FIG. 2 and with particular reference to the schematic illustration of the PCB 140 illustrated in FIGS. 3 and 4.

Collectively, FIGS. 3 and 4 illustrate the internal electronic components of the device 100, along with additional details relating to components to allow the device 100 to communicate with other devices and systems. FIG. 3 is a schematic diagram of a first surface 220 of the PCB 140 and FIG. 4 is a schematic diagram of an opposite second surface 225 of the PCB 140. It should be understood that reference to the components being on the first or second surfaces 220, 225 of the PCB 140 is for convenience and illustration purposes only and is not meant to be limiting with respect to a particular configuration/arrangement of the PCB 140.

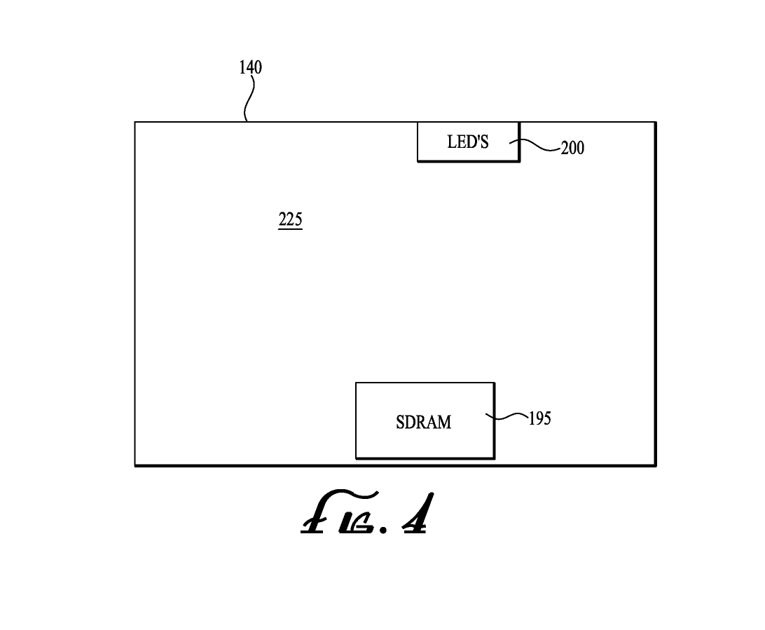

With particular reference to FIG. 3, the device 100 includes a controller or processor 145, which may be any of various suitable commercially available processors or other logic machine capable of executing instructions. In some embodiments, the controller/processor 145 may be a 32 Bit microprocessor, although other suitable microprocessors, including multi-processor architectures may also be employed as the processor 145. As briefly described previously, when the device 100 is connected to the on-site monitoring system 150 via the connector body 120 (or the connector body 130) and the connector pins 132, the processor 145 obtains information (e.g., fuel level, error codes, and other data) from the on-site monitoring system 150 and transmits the information to a central server 155, where the information can be reviewed by an operator or otherwise disseminated to other interested parties as is further described in detail below with reference to FIGS. 5-8.

The device 100 includes a network interface 160 to facilitate communication from the device 100 with one or more other devices, such as a server 155 or a suitable electronic device 160 (e.g., a mobile device, phone, computer, or any other device). The network interface 160 may facilitate wired or wireless communication with other devices over a short distance (e.g., Bluetooth™) or nearly unlimited distances (e.g., via the Internet). Preferably, the device 100 uses a wireless connection, which may use low or high powered electromagnetic waves to transmit data using any wireless protocol, such as Bluetooth™, IEEE 802.11b (or other WiFi standards), infrared data association (IrDa), and radio frequency identification (RFID). In the case of a wired connection, a data bus may be provided using any protocol, such as IEEE 802.3(Ethernet), advanced technology attachment (ATA), personal computer memory card international association (PCMCIA), and USB. To facilitate a wired networking environment, the device 100 may further include an Ethernet module 165, a micro USB module 170, or other suitable connection modules. In some embodiments, the device 100 may also include a SIM card 215 to allow for 3G connectivity.

The device 100 further includes a transmitter 175 operable for transmitting data from the device 100 to the server 155 and/or to another suitable device, such as the electronic device 160 (e.g., a mobile phone, tablet, computer display). The device 100 may receive power via an external power supply 180 connected to the device 100 via power input port 185. Alternatively, or in addition, the device 100 may include a battery unit 190 that may serve as the main power source for operating the device 100, or may serve as a backup power source in the event a power outage or other failure results in the inability of the external power supply 180 to supply power. In some embodiments, the battery unit 190 may be removable and replaceable as needed.

In some embodiments, the device 100 forms a component of a larger monitoring system 205 that includes the server 155 and the electronic device 160, which is in wireless or wired communication with the server 155 as described previously. The electronic device 160 includes a display screen 210 configured to present to the operator, or other user, collected data (such as fuel levels, error codes, or other fuel information) gathered from the on-site monitoring system 150 via the monitoring device 100. In some embodiments, the operator may use the electronic device 160 to provide instructions to the server 155 relating to generating advertisements for fuel customers and fuel providers, for handling detected issues (e.g., fuel leaks, high/low temperature, etc.), and/or for otherwise manipulating the data obtained via the monitoring device 100 as is further explained below with reference to FIGS. 5-8.

With reference to FIG. 4, the device 100 includes a memory unit 195, which may be implemented using one or more standard memory devices, such as SDRAM, RAM and ROM devices. In one embodiment, any number of program modules may be stored in the memory unit 195, including an operating system, one or more application programs, stored files, customer data, storage tank data, device settings, and/or any other suitable modules for operation of the device 100. The device 100 may further include one or more illumination sources 200, such as light-emitting diodes (LEDs), that may be illuminated to indicate a status of the device 100. For example, in one embodiment, the illumination sources 200 may be green to indicate that the device 100 is operating in a normal capacity, yellow to indicate that the device 100 may require maintenance (e.g., the battery unit 190 is low, or the power supply 180 is not connected via the battery port 185), and red to indicate the device 100 is inoperable.

The above-described components of the device 100, including the processor 145, the network interface 160, the Ethernet module 165, the USB module 170, the transmitter 175, and the memory 195 may be interconnected via any suitable architecture, such as a bus-type architecture. In addition, while the illustrated embodiment depicts one possible configuration for the device 100, it should be recognized that a wide variety of hardware and software configurations may be provided without departing from the principles of the described embodiments. For example, other versions of the device 100 may have fewer than all of these components or may contain additional components.

FIGS. 5-8 collectively illustrate example methods for installing and using the device 100 to obtain information from the on-site monitoring system 150 and to transmit collected data to a central server 155 where the data may be reviewed/received in part or in whole (a) by gas station owners or other operators/personnel for monitoring the status of various gas stations; (b) by fuel refineries or other fuel providers to anticipate fuel delivery needs from gas station owners; and/or (c) by fuel consumers to determine whether any promotions may exist in their area. Each of these example methods for using the device 100 is described in additional detail with reference to FIGS. 5-8.

It should be understood that while the description of the method steps may present and describe certain steps in a particular order, the order is for convenience and is not meant to be limiting. In some embodiments, the steps may be performed in an order different than what is specified herein. In addition, the method may include additional steps and features other than those included herein. In some embodiments, the method may combine certain steps or omit certain steps altogether.

With reference to FIG. 5, the method 500 illustrates an example embodiment relating to configuring the monitoring device 100 and preparing for installation and use of the device 100 with the on-site monitoring system 150. At step 502, a user obtains a monitoring device 100, such as by renting or purchasing the device 100 from a vendor. Thereafter, at step 504, the user connects the monitoring device 100 to the on-site monitoring system 150, such as by inserting the connector body 120 (or 130) of the device 100 into the corresponding communication serial port of the on-site monitoring system 150. In some embodiments, such as where other devices 100 may already be connected to the communication serial port, the second connector body 130 may be used to allow any device that was previously connected to the communications serial port to remain connected through the device 100. In this fashion, the monitoring device 100 is able to accommodate any previous configurations/use of the on-site monitoring system 150 without interruption.

Thereafter, at step 506, the user enables Internet connectivity of the device 100. In one embodiment, to enable Internet connectivity, the user may connect a router, modem, or switch to the device 100 via the device's Ethernet module/port 165. In other embodiments, Internet connectivity may occur wirelessly, such as via Bluetooth or other wireless system. At step 508, the user connects the power supply to the power port to power the monitoring device 100. In other embodiments, after the monitoring device is connected to the on-site monitoring system 150, the device 100 may draw power from the on-site monitoring system 150 (or from its respective power source) instead of relying on an external power source.

After the device 100 is powered and Internet connectivity is enabled, at step 510, the device 100 obtains an IP address and tests communication with the on-site monitoring system 150. The IP address information and other data may be pushed to and stored on the central server 155. Once this process is complete, the LEDs 200 on the device 100 may activate to indicate power status, TCP/IP connectivity, communication status with the on-site monitoring system 150, or other features.

At step 512, the user downloads software, such as an application or program, to a mobile phone, computer, tablet, or other suitable electronic device, where the application/program may be used to interact with the monitoring device 100 (such as to send control commands) and/or to interact with the central server 155 (such as to review data obtained from the on-site monitoring system or obtain other data). Once the application is downloaded to the selected electronic device, at step 514, the user accesses the application or program, creates an account, and inputs unique key information and other access codes to configure and activate the monitoring device 100. For example, in some embodiments, the user may input a unique key such as a MAC address or serial number that may be affixed to the package and/or to the device 100. In some embodiments, the unique key information may also be embedded into the controller software so that the information cannot be altered. In other embodiments, the unique key may be provided to the user such as via an email, text, or over the phone.

At step 516, the user inputs into the application or program a corresponding key or other identification information for the specific on-site monitoring system 150 with which the monitoring device is to be used. Once the unique key information for the monitoring device 100 and the on-site monitoring system 150 is entered (as described in steps 514 and 516 above), the server pairs/links the monitoring device 100 and the on-site monitoring system 150 together so that the monitoring device 100 is paired to the specific on-site monitoring system 150. This pairing may help avoid many potential issues that may occur from swapping monitoring devices between various on-site monitoring systems, such as: errors relating to accurate fuel level monitoring, errors in coordinating fuel ordering/delivery schedules, and may lead to other errors/inconsistencies, such as with inventory values. Accordingly, it is advantageous to maintain the device 100 paired with a specific on-site monitoring system 150.

Once the on-site monitoring system 150 and the monitoring device 100 are paired together, and the account has been properly activated, the operator/user may be able to access a variety of data across a portfolio/network of gas stations. For example, in one embodiment, the operator may be able to obtain volume information relating to the amount of fuel remaining in a storage tank, error codes, fuel temperature/pressure information, and other information for each storage tank in a variety of gas stations. In other embodiments, the server 155 may also compile and/or store ancillary information that may or may not be obtained via the monitoring device 100, such as historical sales data for specific gas station sites. The ancillary data, in conjunction with data obtained via the monitoring device 100, may be used to provide tools for the operator to develop a complete picture for every gas station across a portfolio. For example, the operator may compare current fuel sales (which may be obtained from sales data or may be extrapolated from fuel level and/or delivery data obtained from the monitoring device) and compare to historical sales.

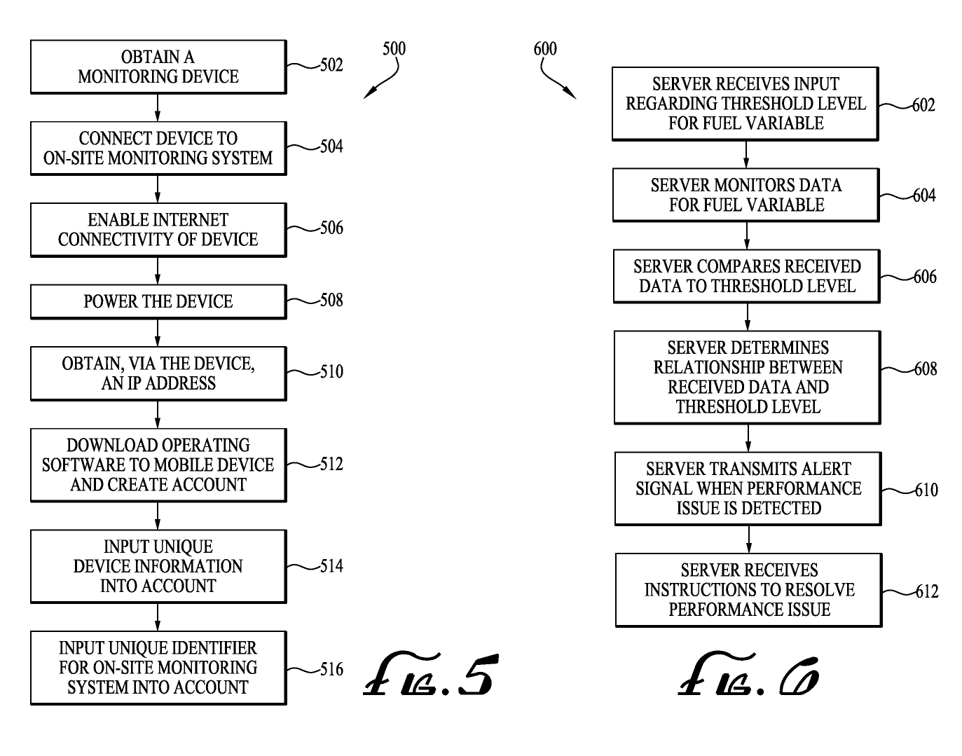

In still other embodiments, the operator/user may use the application or software program to create an alert system that sends alerts to the user in response to the occurrence of a specific monitored event. For example, in one embodiment, the monitored event may be a specific fuel level threshold. In such embodiments, the server 155 may send an alert or message (e.g., a push notification or email) when the monitored fuel level in a storage tank dips below a certain specified volume or exceed a specified volume. In one example, the server 155 may send a message to the account user with a reminder to schedule a delivery when the fuel levels are low, or to schedule maintenance when the fuel levels are above a threshold for safety. FIG. 6 illustrates an example embodiment of an alert method 600 using the monitoring device 100 of FIGS. 1-4.

With reference to FIG. 6, at step 602, the server 155 receives input from a user relating to a threshold level for a particular variable about which the user wishes to be alerted. For example, in one embodiment, a user may want to know when the fuel level drops below a certain volume or exceeds a certain volume, or when the temperature in the storage tanks drops below or raises above a threshold level, or another suitable variable. At step 604, the server 155 monitors the data received via the monitoring device 100 relating to a variety of parameters, including the variable for which the alert has been requested. At step 606, the server 155 compares the data received from the monitoring device 100 to the threshold levels and, at step 608, determines whether the monitored variable is above or below the threshold level.

For instance, in one example embodiment, the operator may request an alert when the fuel level dips below a specific volume. In such embodiments, the server 155 compares the fuel level data obtained from the monitoring device 100 with the desired threshold level input by the user. When the server 155 determines that the fuel level is below the threshold level, at step 610, the server 155 transmits an alert signal to the user. The alert signal may be any one or more of a variety of signals, such as a voice message, a text message, a push notification, an email, a phone call, or other suitable signal. In response to receiving the alert signal, the user may transmit instructions to the server 155 for resolving the issue. At step 612, the server 155 receives instructions from the user relating to steps for resolving the issue. For example, in one embodiment, when the alert signal indicates that the fuel level is below the threshold level, the user may send instructions to the server 155 to deactivate the signal because the user has placed an order with a fuel delivery service to refill the storage tank.

In another embodiment, instead of (or in addition to) receiving instructions from the user at step 612, the server 155 may automatically resolve the issue based on prior instructions received from the user. For example, after generating the alert signal, the server 155 may automatically contact a fuel provider and order fuel to refill the storage tank to a particular level. In such embodiments, the server 155 may receive prior instructions from the user for handling certain situations. For example, during account setup or at any time thereafter, the user may instruct the server 155 to automatically request delivery from a specific fuel provider for a preset number of gallons to the storage tanks when the fuel volume indicates the tank is ¾ empty. In other embodiments, the user may instruct the server 155 to order fuel only after a predetermined time delay (e.g., 12 hours, one day, one week, etc.) has passed without the server 155 having received a follow up message from the user with instructions for resolving the issue. For example, the user may set a delay of 12 hours after the server 155 indicates that the fuel level is below a specific threshold. The user may set this delay to give the user an opportunity to contact the fuel provider and place a specific fuel order. Once the user places the order, the user may provide instructions to the server 155 to take no further action. If the predetermined amount of time has passed with no instructions to the server 155, the server 155 may automatically resolve the issue in accordance with prior instructions from the user.

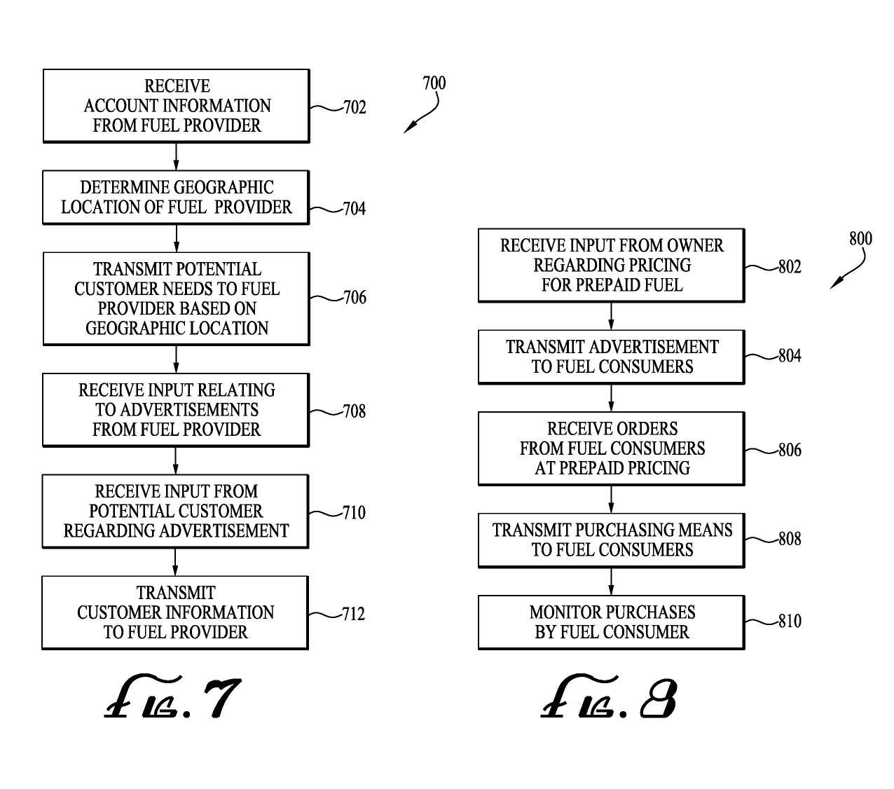

As mentioned previously, a fuel refiner or provider may also use the data from the monitoring device 100 to anticipate and coordinate fuel delivery for various consumers to avoid having fuel delivery trucks return to the refinery with undelivered fuel. FIG. 7 illustrates an example method 700 relating to a fuel refinery or provider using some or all of the data obtained by the monitoring device 100 of FIGS. 1-4 for determining an optimal fuel delivery strategy. With reference to FIG. 7, at step 702, the server 155 may receive account information from a fuel provider to create an account with the server 155. The account may provide the fuel provider access to some or all of the raw data or information obtained from the monitoring device 100, or may otherwise provide access to a synthesized or summarize version of the obtained data. For example, the fuel provider may receive aggregate fuel consumption data or fuel level data for storage tanks at specific sites. In some embodiments, the amount and type of data that the fuel provider receives may be controlled and customized by the owner, manager, or other personnel that owns the on-site monitoring system 150.

In addition, the account information may provide identification information for one or several fuel trucks, and also provide the server 155 the capability to track a geographic location of the fuel trucks. At step 704, the server 155 determines a geographic location relating to a position of a fuel delivery truck, transport vehicle, or other delivery means of the fuel provider. In some embodiments, the server 155 may receive GPS data from the vehicle or may receive direct input from the fuel provider via the program or application software.

At step 706, the server 155 transmits information to the fuel provider relating to other potential consumers located within a predetermined region (in relation to the determined geographic location of the fuel delivery truck), including information relating to an amount of fuel that the identified potential customer may require. For example, in one scenario, the fuel provider may have 6,000 gallons of undelivered fuel remaining in a fuel truck after completing a delivery route. The fuel truck may have excess fuel because a customer may no longer require the amount of fuel ordered, or the amount of fuel was not properly determined by the fuel provider when the fuel truck was filled, or for any other reason. The server 155 may identify a potential consumer (e.g., a fueling station) within two miles of the fuel delivery truck's current location that requires 3,000 gallons of fuel and may identify another potential customer in the same vicinity that requires another 2,000 gallons of fuel. Accordingly, the server 155 may notify the fuel provider of the location of the potential customers and their respective fuel needs. With this information, the fuel provider may contact the potential customers to determine whether the customers would be interested in acquiring additional fuel.

At step 708, the server 155 receives input from the fuel provider to advertise to customers and provide offers relating to the remaining fuel in the current delivery. In some embodiments, the advertisements may be directed specifically at the identified customers that may be within a specific range of the geographic location of the fuel provider. For example, in the above scenario, the fuel delivery truck would contain approximately 1,000 gallons of fuel after delivery to the two potential customers. Accordingly, the server 150 may receive input from the fuel provider to transmit an advertisement relating to the remaining 1,000 gallons of fuel.

At step 710, the server 155 may receive input from one or more potential customers that may have received the advertisement. For example, a customer may express interest in the 1,000 gallons of fuel and may offer a price to purchase the remaining fuel, or may respond to a price posted by the fuel provider in the advertisement for the 1,000 gallons of fuel. When a customer expresses interests in the delivery of the remaining fuel, at step 712, the server 155 may transmit customer information to the user (e.g., business address, amount of fuel requested, price, etc.) to complete the transaction.

In other embodiments, the fuel providers may also consult the server 155 to determine an accurate reading of the fuel levels for specific sites to determine an expected volume of fuel for delivery. In still other embodiments, the server 155 may provide a digital heat map of fuel consumption by region, area, or market to better allow fuel refineries and providers to plan for demand.

As mentioned previously, the data from the monitoring device 100 may also be used by fuel customers/end users to evaluate real-time information relating to fuel availability and pricing. FIG. 8 illustrates an example method 800 relating to a fuel customer using some or all of the data obtained by the monitoring device 100 of FIGS. 1-4. In some embodiments, a fuel consumer may create an account with the server 155 to obtain information, such as advertisements or a comparison of fuel prices for a variety of gas stations. The fuel consumer may also receive discounts, loyalty reward points, or other incentives through the server 155 as determined by the fuel dispensary owners or others. In other embodiments, the server 155 may allow consumers to pre-purchase fuel at set prices based on a variety of factors. The following describes additional details relating to a method for pre-purchasing fuel.

With reference to FIG. 8, at step 802, the server 155 may receive input from a fuel dispensary owner relating to a pricing structure for pre-purchasing fuel. For example, the promotion may relate to the sale of a predetermined quantity of gas at a set price per gallon. At step 804, the server 155 may transmit the advertisement to a plurality of fuel consumers. In some embodiments, the advertisements may include a map that provides various pricing structures for a variety of fueling stations within a specified geographic location. At step 806, the server 155 receives orders from fuel consumers for fuel at the set pricing structure. At step 808, the server 155 transmits a code (such as a bar code or a QR code), sends a physical or electronic preloaded transaction card, or otherwise provides a suitable means for verifying and deducting an actual purchase against the fuel consumer's running balance.

For example, in one embodiment, the fuel dispensary owner may set a pricing structure for 50 gallons of gas at a discounted price per gallon. Thereafter, a fuel consumer purchases the 50 gallons up front and receives a physical transaction card in the mail. The user then visits a gas station and obtains 15 gallons of gas, which the user pays by swiping the transaction card. Upon completing the transaction, at step 810, the server 155 deducts the 15 gallons of purchased gas from the initial total, leaving a running balance of 35 gallons of gas for future purchases.

In other embodiments, the server 155 may also transmit other advertisements relating to services that may be available at the fueling station. For example, the advertisements may include discounts or promotional offers for car wash and detailing services, or specials for food that may be served at the site. In still other embodiments, the server 155 may further receive input from fuel consumers relating to pricing of other businesses that may compete with the advertiser. In such embodiments, the server may transmit the information to the fuel dispensary owner to allow the owner to adjust the pricing structure if desired.

It should be understood that while the methods for using and installing the monitoring device have been described in a particular order, the described order is merely for illustration purposes only and is not intended to enumerate a specific order of steps. In other embodiments, the steps in the described methods may be accomplished in a different order without affecting the outcome of the process.

It is intended that subject matter disclosed in any one portion herein can be combined with the subject matter of one or more other portions herein as long as such combinations are not mutually exclusive or inoperable. In addition, many variations, enhancements and modifications of the concepts described herein are possible.

The terms and descriptions used above are set forth by way of illustration only and are not meant as limitations. Those skilled in the art will recognize that many variations can be made to the details of the above-described embodiments without departing from the underlying principles of the invention.

1. A monitoring system for managing fuel distribution systems, the monitoring system comprising:
a database;
a monitoring device, comprising:
a connector having one or more engagement features operable to connect to a communications port on a fuel distribution system;
a processor operable to communicate with the fuel distribution system when the connector is connected to the communications port, the processor configured to obtain fuel information from the fuel distribution system; and
a transmitter in operative communication with the processor and in wireless communication with the database, the transmitter configured to transmit to the database the fuel information obtained by the processor from the fuel distribution system; and
an electronic device in communication with one or both of the database and the monitoring device, the electronic device having a display screen configured to present the fuel information obtained from the fuel distribution system.

2. The monitoring system of claim 1, wherein the fuel information comprises a fuel level for fuel stored in the fuel distribution system.

3. The monitoring system of claim 1, wherein the database is further configured to determine whether a performance issue exists relating to the fuel distribution system based on the obtained fuel information.

4. The monitoring system of claim 3, wherein when a performance issue is identified, the database is further configured to communicate the performance issue to the electronic device, the electronic device further configured to present the performance issue on a display screen.

5. The monitoring system of claim 4, wherein the electronic device is further configured to receive a protocol containing instructions for resolving the performance issue.

6. The monitoring system of claim 3, wherein the database is further configured to transmit an alert signal to the electronic device when a performance issue is identified.

7. The monitoring system of claim 3, further comprising a memory module in communication with the database, the memory module storing therein a protocol containing instructions for resolving the performance issue when identified.

8. The monitoring system of claim 7, wherein the database is further configured to query the memory module to obtain the protocol, and automatically resolve the performance issue based on the instructions contained in the protocol.

9. A method for managing a fuel distribution system via a monitoring device connected to a communications port of the fuel distribution system, the method comprising:
obtaining, via the monitoring device, fuel diagnostics information from the fuel distribution system;
transmitting, via transmitter of the monitoring device, the fuel diagnostics information to a database;
comparing, via the database, the fuel diagnostics information received from the monitoring device with baseline diagnostics information stored in the database to identify whether a performance issue exists;
transmitting, via the database, the fuel diagnostics information and the performance issue to an electronic device;
displaying, via the electronic device, the fuel information and the performance issue; and
resolving, via the database, the performance issue.

10. The method of claim 9, wherein the fuel diagnostics information comprises a measured fuel level, and wherein resolving the performance issue further comprises:
comparing, via the database, the measured fuel level to a threshold fuel level;
querying, via the database, a memory module for a protocol containing instructions for resolving the performance issue.

11. The method of claim 10, further comprising automatically resolving, via the database, the performance issue by executing the protocol.

12. The method of claim 11, wherein the protocol contains instructions to order a predetermined amount of fuel, and wherein automatically resolving the performance issue comprises ordering from a fuel provider the predetermined amount of fuel.

13. The method of claim 9, wherein displaying the performance issue further comprises generating, via the electronic device, an alert signal.

14. The method of claim 13, wherein resolving the performance issue further comprises receiving input, via the database, the input including instructions for resolving the performance issue.
